(19) United States
(12) Patent Application Publication
(10) Pub. No.: US 2004/0150185 A1
(43) Pub. Date: Aug. 5, 2004

(54) Front wheel drive handlebar for use with bicycles

(76) Inventor: Simon Thomas Gonsalves, Santa Fe, NM (US)

Correspondence Address: Simon T. Gonsalves, 993 Calle Feliz, Santa Fe, NM, 87507, US

(21) Appl. No.: 10/353,253

(22) Filed: Jan. 30, 2003

(51) Int. Cl. B62M 1/00; B62M 1/14

(52) U.S. Cl. 280/234; 280/244

(57) ABSTRACT

A front wheel drive fork is provided wherein the arm powered handlebar provides mechanical means for transforming the linear stokes of the rider to the rotary propelling of the front wheel. The front wheel drive is an improvement to existing cycles, is utilized to exercise the upper and lower extremities, and provides more traction to cyclists.

### BACKGROUND OF THE INVENTION

1. Field of the Invention

This invention relates in general to bicylces, and in particular to bicycles having arm powered front wheel drives.

2. Prior Art

Many types of rotary front wheel drive bicycle fork units have been provided U.S. patents such as to Hartley, U.S. Pat. No. 484,712; Hundnall, U.S. Pat. No. 3,485,508; Winters, U.S. Pat. No. 3,823,959; Harper, U.S. Pat. No. 4,109,927; Phillips, U.S. Pat. No. 4,773,662; Rodriguez, U.S. Pat. No. 4,858,942; and Dodakian, U.S. Pat. No. 5,816,598. Some front wheel driven bicycles use a combination of rotary drive connected through linkage to oscillating handlebars such as Murray, U.S. Pat. No. 565,556; Lindsey, U.S. Pat. No. 4,147,370; Patroni, U.S. Pat. No. 4,548,420; and Jeranson, U.S. Pat. No. 5,431,614. Deutch, U.S. Pat. No. 5,039,122 uses two linear drive handles attached to one way clutches which are then connected to endless chains driving the front wheel. Sommer, U.S. Pat. No. 5,328,195 uses a drive line coupled to a ratcheting front wheel. None of these patents accomplish the goals of the present invention.

### SUMMARY OF THE INVENTION

The principal object of the present invention is to transfer the horozontal linear movement of the pivoting handlebar into rotary foward vertical movement of the front wheel.

Another object of the present invention is to provide a front wheel drive for a conventional bicycle in which all hand operated devices used to control the bicycle may still be mounted on the handlebar as usual. Hand operated devices defined as, but not limited to brake levers, gear shifters, and speedometers.

A still further object of the present invention is to provide a means by which the pivoting handlebar can be made not to pivot but to function as a regular handlebar. A solid steerable handlebar is important for controlling the bicycle on treacherous terrain.

The next object of the present invention is to provide a lightweight front wheel drive fork assembly as an improvement to existing and former bicycles.

The present invention also has fewer exposed moving parts which leads to ease of maintenance. Because the present invention has fewer parts, ease of manufacter is another advantage.

These and other objects and advantages of the present invention will become apparent with reference to the drawings, the description of the preferred embodiment and the appended claims.

### BRIEF DESCRIPTION OF THE DRAWINGS

FIG. 1 is an isometric view illustrating the oscillating linear drive handlebar and front wheel of the present invention.

FIG. 2 is a front elevation view of the present invention.

FIG. 3 is a side elevation view of the present invention.

FIG. 4 is a fragmentary sectional view taken on the line 4--4 of FIG. 1.

FIG. 5 is a fragmentary sectional view taken on the line 5--5 of FIG. 1.

FIG. 6 is a side elevation of a fragmentary sectional view taken on the line 6--6 of FIG. 1.

FIG. 7 is a rear elevation of a fragmentary sectional view taken on the line 6--6 of FIG. 1.

FIG. 8 is a fragmentary isometric view taken on the line 8--8 of FIG. 1.

FIG. 9 is a fragmentary side elevation view taken from the line 8--8 of FIG. 1.

FIG. 10 is a fragmentary sectional diagram taken from the lines 8--8 and 10--10 of FIG. 1.

FIG. 11 is a fragmentary isometric view taken from the line 11--11 of FIG. 1.

FIG. 12 is a fragmentary side elevation view taken from the line 12--12 of FIG. 1.

FIG. 13 is a fragmentary side elevation view taken from the line 13--13 of FIG. 1.

### DETAILED DESCRIPTION

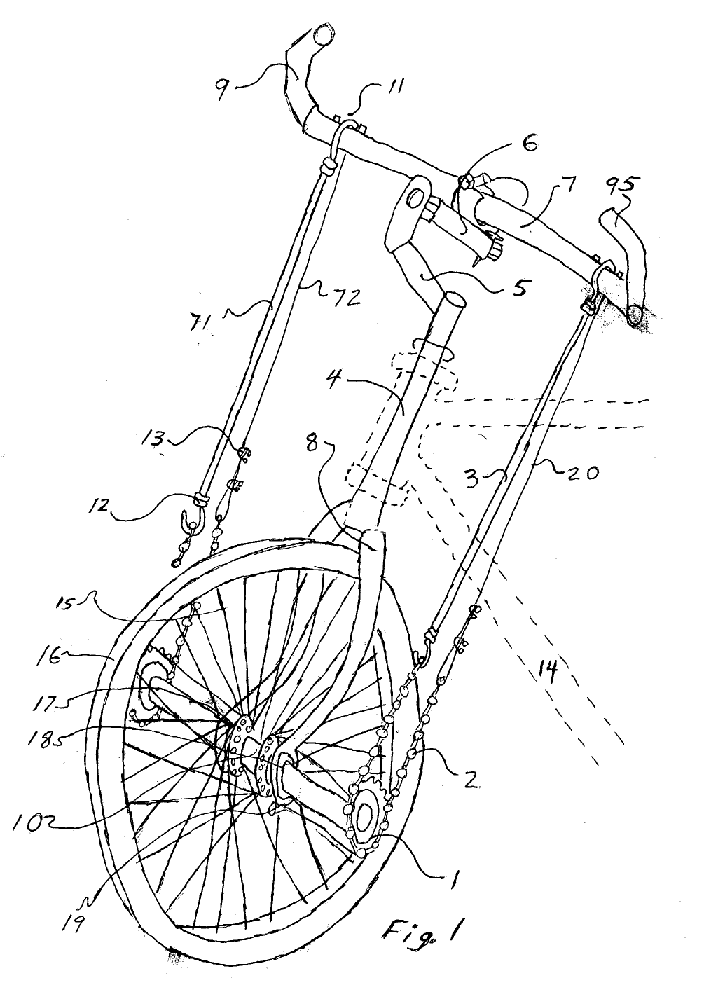

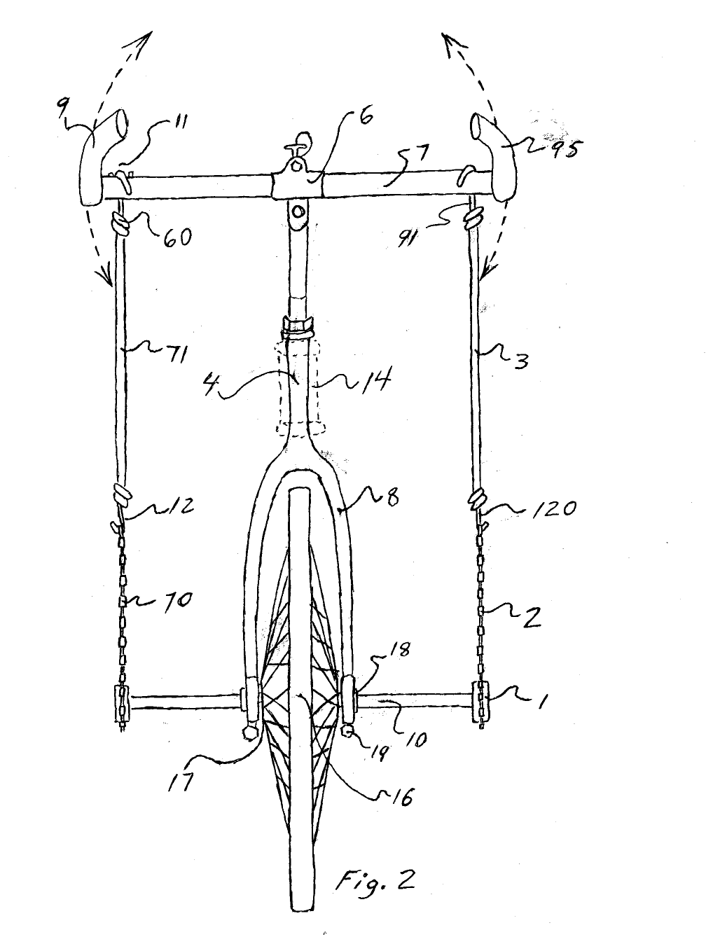

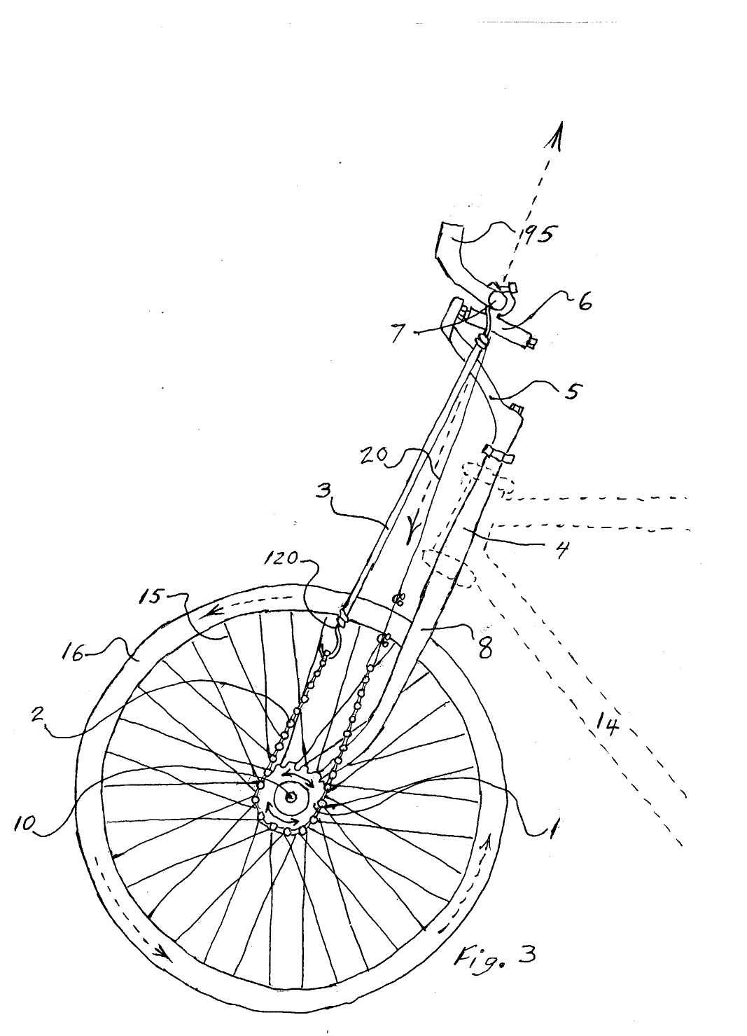

Refer now to FIG. 1, which is an overall drawing of a preferred embodiment of the invention. The numeral 14 indicates the existing frame of a usual bicycle. The front wheel 16, rotates on axel 10, and is driven foward by the handlebar 7, which is connected to a freewheeling clutch 1, by means of a length of chain 2, a length of cable 20, and a length of elastic cord 3.

The numeral 15 indicates one of several tentionable spokes and is connected to the rim of the front wheel 16, to the axel 10, by means of the spoke hub 17. The axel assembly 10, is mounted in bearings 18, which rotate in the front fork 8, attached by binding screw 19.

The handlebar 7, rotates on axel assembly 6, mounted on handlebar neck 5, inside steering tube 4, affixed to forks 8. The numeral 9 indicates handlebar ends. Elastic cord 3, and cable 20, are connected to handlebar 7, at retainer mount 14.

The numeral 12 indicates means by which elastic cord 3, is connected to chain 2. The numeral 13 indicates connection between cable 20, and chain 2.

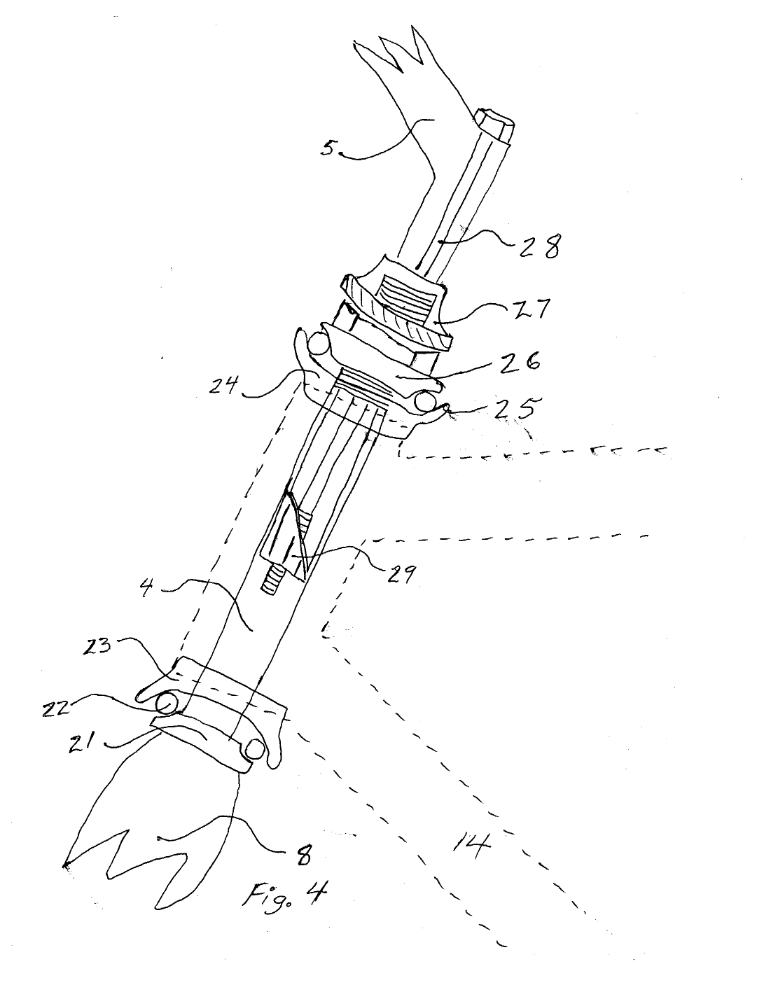

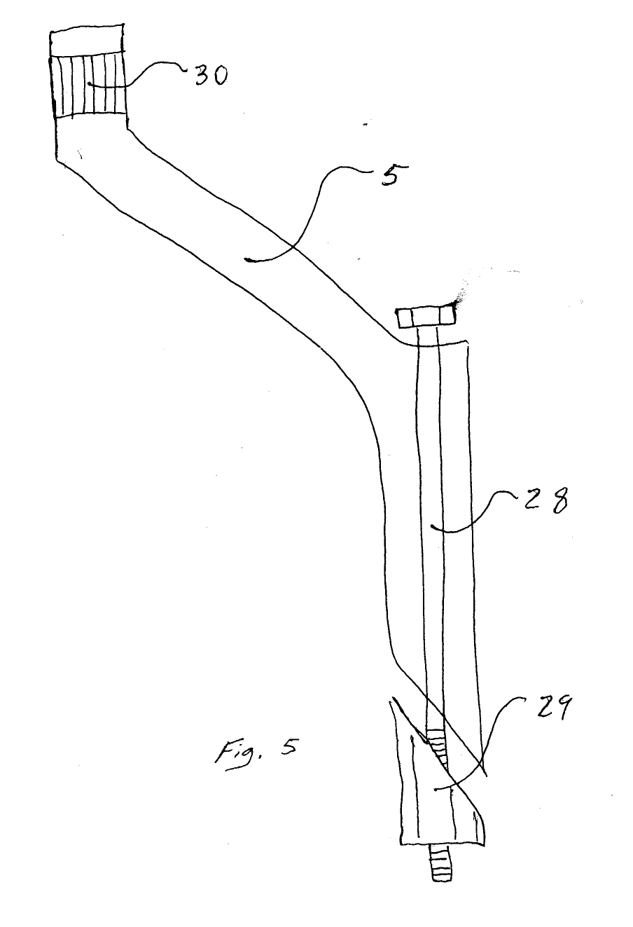

In FIG. 4 the steering tube 4, is affixed to the forks 8, the handlebar neck 5, and is mounted in the frame of an existing bicycle 14. The steering tube 4, is then connected to cone races 21 and 26 which rotate on ball bearings 22 and 25 against races 23 and 24 which are mounted in the existing bicycle frame 14. The top of the steering tube 4, is threaded and binding nut 27, secures the steering tube 4, to the existing bicycle frame 14. Bolt 28 expands wedge 29, against handlebar neck 5, thusly allowing handlebar neck 5 to be adjusted up and down. The handlebar neck 5, holds axel assembly 6, in threaded hole 30, of FIG. 5.

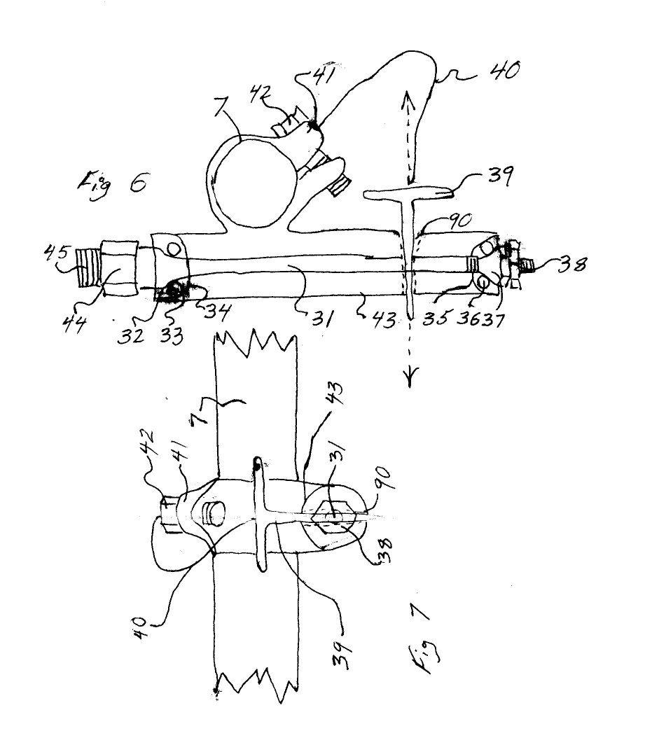

in FIG. 6 the binding bolt 42, tightens the handlebar 7, to the binder body 41, affixed to axel body 43. The axel body 43, is mounted on cup races 34 and 35, which rotate on ball bearings 33 and 36, against cone races 32 and 37, which are integrated into axel 31. One end of axel 31, has thread integration 45 and hexagonal teeth 44, for mounting to threaded hole 30 of FIG. 5. The other end of axel 31 is threaded to accept end cone race 37, and binding nut 38, which oppose each other securing the axel body 43, to the axel 31. Numeral 39 in FIGS. 6 and 7 indicates a removeable locking pin which pierces hole 90drilled through the axel body 43, and the axel 31. The locking pin is connected to a retaining cable 40.

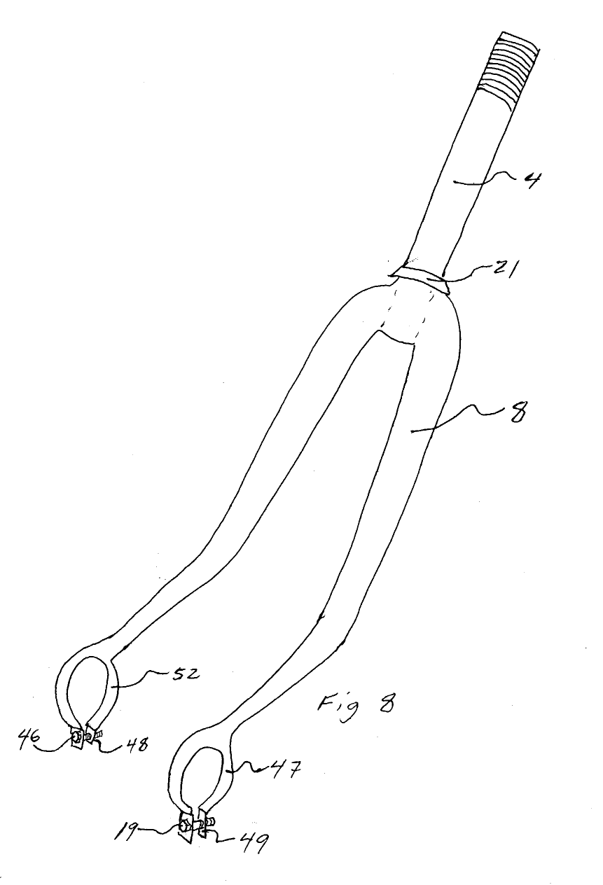

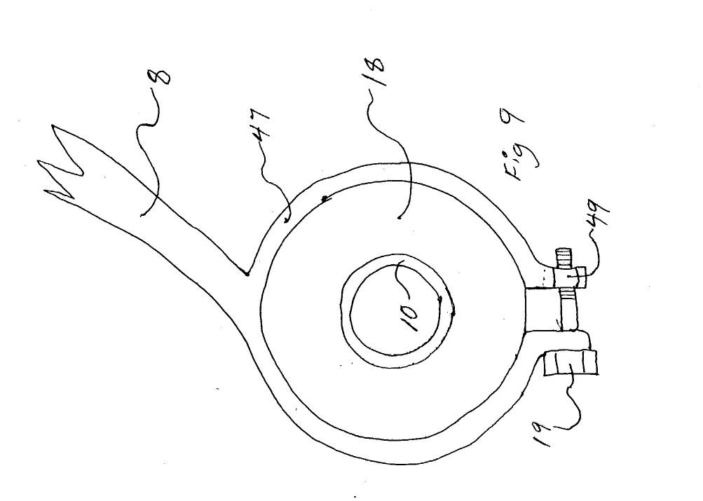

In FIG. 8 the fork 8, is attached to steering tube 4, the bottom of which is encircled with lower cone race 21. In FIG. 9 the fork end 47, hold bearing 18, which is compression fit onto axel 10. The fork end binding screw 19, passes through a threaded hole 49, integrated into fork end 47.

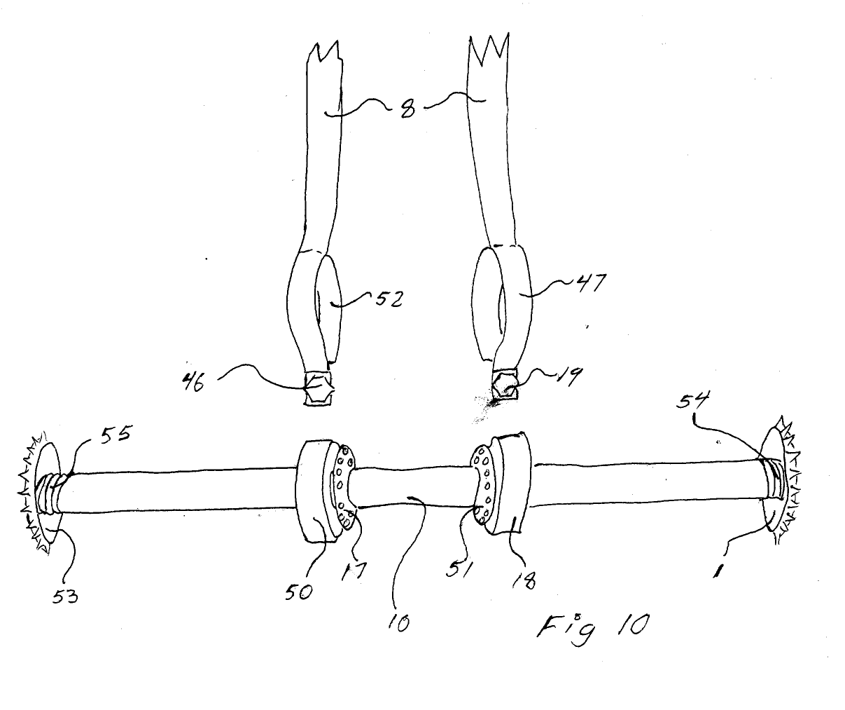

In FIG. 10 the main axel 10, has been attached to left and right side spoke hubs 51 and 17 respectively. The inner diameter of bearings 18 and 50, is compression fit onto the portion of the main axel 10, closest to spoke hubs 17 and 51. The left hand side of the axel end 54, is externally left hand threaded to accept the internal left hand threads of the left hand side freewheeling clutch 52. Likewise, the right hand side of the axel and 55, is externally right hand threaded to accept the internal right hand threads of the right hand side freewheel 53. The freewheeling clutches 52 and 53, are externally toothed to accept chains 2 and 70, respectively. Fork ends 47 and 48, fit over bearings 18 and 50.

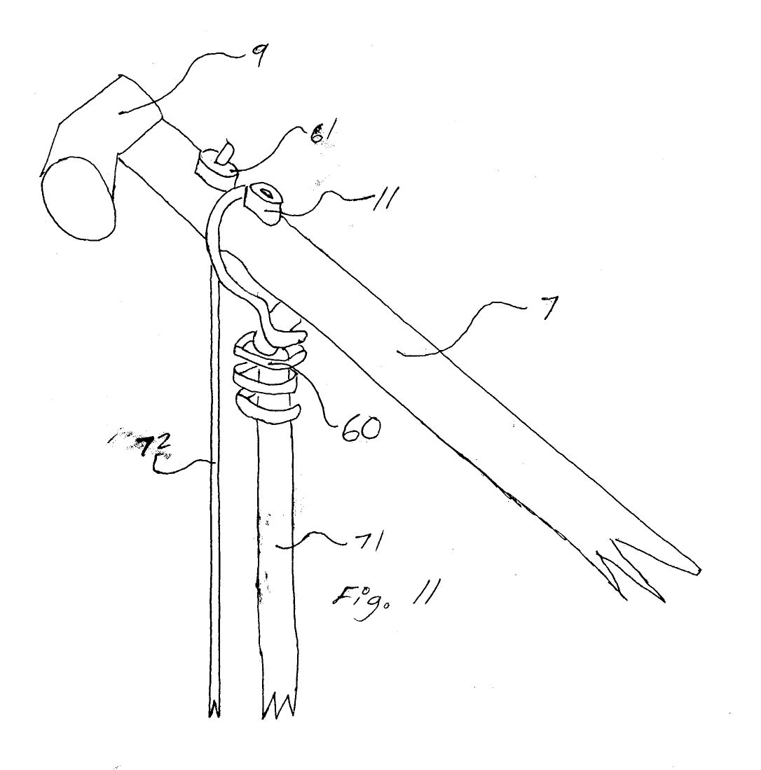

in FIG. 11 cable 72, is retained through cable stop 61. Elastic cord hook 60, is retained between cable stops 11 and 61. Handlebar end 9, is mounted on handlebar 7.

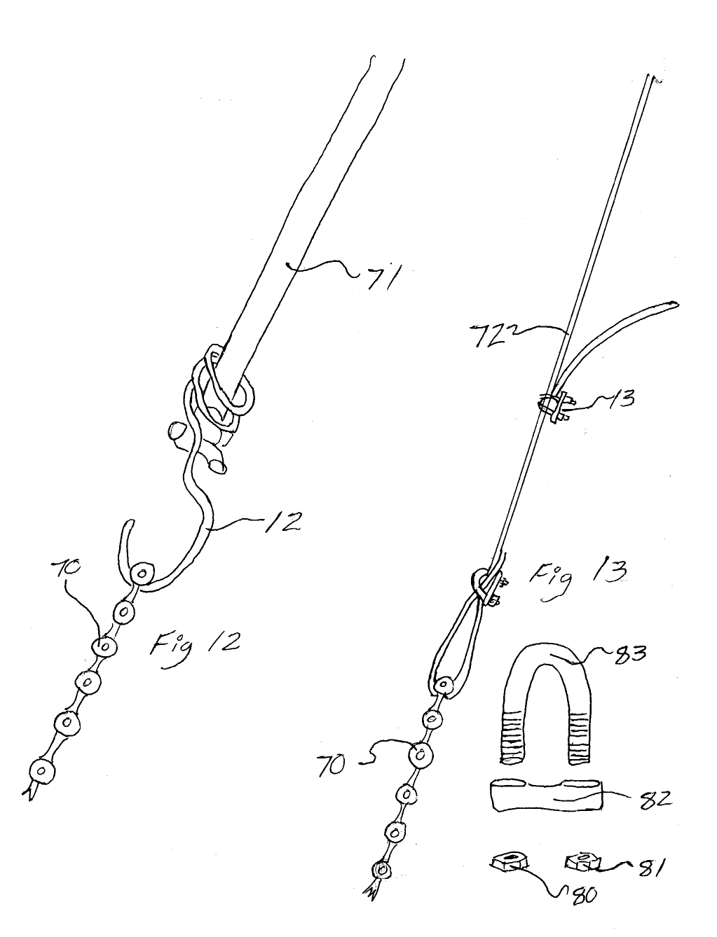

FIG. 12 is a detail of elastic cord hook 12 connecting to right hand chain 70. FIG. 13 shows a detail of cable crimpers 13, and cable 72 attachment to chain 70. Cable is crimped to threaded U shaped bolt 83, is held by yoke 82, and crimping nuts 80 and 81.

The parts can be made of any suitable material and in different shapes and sizes as desired or required.

From the foregoing it will be seen that there has been produced a bicycle front wheel drive wherein an oscillating handlebar 7 provides a novel original and efficient mechanical form of transforming the linear strokes of the operator to the device propelling the bicycle foward. In operation, all parts on the left side of the front wheel 16 mirror and work independently of all parts on the right side of the front wheel 16. The operator grasps the handlebar ends 9 and 85, of the handlebar 7 which pivots on an axel 6. The rider is pushing down on one side of the handlebar 7 and pulling up on the other side. One of the cables 20 or 72 will pull one of the chains 2 or 70 and turn one of the freewheeling clutches 1 or 53 and turn the front wheel16 foward. For example, the rider pulls on left side of handlebar 7 while simultaneously pushing on right side of handlebar 7. The left side cable 20 will pull on the left side chain 2 thus driving the left side freewheeling clutch 1 foward. Upon reaching full extention of stroke or end of chain 2, the rider will then push the left side of handlebar 7, and pull the right side of handlebar 7. At this the left side elastic cord 3 will retract returning chain 2 and cable 20 to their original postions. Meanwhile the right side cable 72 pulls the right side chain 70 advancing the right side freewheeling clutch 53 again moving the front wheel 16 foward. At rest the rider may choose to lock the handlebar 7 at mid position by inserting removeable locking pin 39 into hole 90 of axel assemblies 31 and 43. Thus, the rider has locked the pivoting handlebar. Upon removing the locking pin 39, the rider is again ready to transfer the linear motion of handlebar ends 9 and 95 into rotary motion of front wheel 16.

As shown in FIG. 1 there is provided a driveable front wheel 16 mounted rotatably through steering tube 4 to existing bicycle frame 14. The axel assembly 10 of front wheel 16 extends the length of the hnadlebar 7, the ends of the axel assembly 10 are attached to left and right hand freewheeling clutches, 1 and 53 respectively. The freewheeling clutches 1 and 53 are then attached to handlebar 7 by means of drivelines 20 and 72. Drivelines 20 and 72 retract after advancement through means of elastic cords 3 and 71.

While the present invention has been descibed and illustrated as for use with bicycles it is understood that the present invention can be used for different applications as, for example, a front wheel of a tricycle or scooter for children. Also, the handlebars could be fitted with foot pedals and be driven foward by foot action. The principles of the present invention may also be applicable to other uses such as the special needs of paraplegics and elderly.

It will therefore be understood that while I've shown and described the invention in a preferred form, changes may be made in the structure shown, without departing from the scope of the invention, as sought to be defined in the following claims.

I claim:

1. A bicycle wherein the improvement comprises a front wheel comprising a rotatably supported fork member, said front wheel having a vertically disposed axel assembly mounted in said rotatably supported fork member, said vertically disposed axel assembly extending to the width of a handlebar pivoting at midpoint on a horizontally disposed axel, said handlebar mounted to top of said rotatably supported fork member, said vertically disposed axel assembly comprising left and right side driving freewheels secured to the ends of last named axel, left and right side drivelines connecting said left and right side driving freewheels to left and right side of said pivoting handlebar, said lift and right side drivelines retracting after advancement, and the ability to stop said handlebar from pivoting by means of a locking pin.
